(19) United States
(12) Patent Application Publication
(10) Pub. No.: US 2025/0094796 A1
(43) Pub. Date: Mar. 20, 2025

(54) DIRECT DEPTH PREDICTION

(71) Applicant: QUALCOMM Incorporated, San Diego, CA (US)

(72) Inventors: Amin Ansari, Kirkland, WA (US); Makesh Pravin John Wilson, San Diego, CA (US); Avdhut Joshi, San Marcos, CA (US); Sai Madhuraj Jadhav, San Diego, CA (US)

(21) Appl. No.: 18/467,804

(22) Filed: Sep. 15, 2023

(51) Int. Cl. G06N 3/08; G06N 3/0455; G06N 3/048

(52) U.S. Cl. CPC G06N 3/08; G06N 3/0455; G06N 3/048

(57) ABSTRACT

Example systems and techniques are described for training a machine learning model. A system includes memory configured to store image data captured by a plurality of cameras and one or more processors communicatively coupled to the memory. The one or more processors are configured to execute a machine learning model on the image data, the machine learning model including a plurality of layers. The one or more processors are configured to apply a non-linear mapping function to output of one layer of the plurality of layers to generate depth data. The one or more processors are configured to train the machine learning model based on the depth data to generate a trained machine learning model.

### TECHNICAL FIELD

This disclosure relates to depth prediction for a machine learning model.

### BACKGROUND

Accurate depth estimation may be important for various use cases. For example, accurate depth estimation (e.g., the distance to an object) may be important for obstacle avoidance. Obstacle avoidance may be associated with autonomous driving, assistive and/or warehouse robotics, augmented and/or virtual scene composition, and the like. Accurate depth estimation may also be important for 3D construction of an environment, a spatial scene understanding (e.g., for image editing), and other use cases.

### SUMMARY

The present disclosure generally relates to the use of a non-linear mapping function to derive a depth prediction from an output of a layer of a machine learning model. The layer may be an output layer of the machine learning model, such that the non-linear mapping function is applied to the output of the machine learning model. Alternatively, the layer may be a middle layer, such as the last middle layer, such that the non-linear mapping function is applied in the output layer of the machine learning model. The non-linear mapping function may be chosen based on particular use cases or errors of interest. A system may utilize the depth data generated by the application of the non-linear mapping function to train the machine learning model to generate a trained machine learning model. The trained machine learning model may be used to control operation of a device, such as a vehicle, a robot, or the like, in an environment, such as for the purposes of maneuvering for obstacle avoidance.

In one example, this disclosure describes a system comprising: memory configured to store image data captured by a plurality of cameras; and one or more processors communicatively coupled to the memory, the one or more processors being configured to: execute a machine learning model on the image data, the machine learning model comprising a plurality of layers; apply a non-linear mapping function to output of one layer of the plurality of layers to generate depth data; and train the machine learning model based on the depth data to generate a trained machine learning model.

In another example, this disclosure describes a method comprising executing a machine learning model on image data captured by a plurality of cameras, the machine learning model comprising a plurality of layers; applying a non-linear mapping function to output of one layer of the plurality of layers to generate depth data; and training the machine learning model based on the depth data to generate a trained machine learning model.

In another example, this disclosure describes a non-transitory, computer-readable storage medium, comprising instructions, which, when executed, cause one or more processors to execute a machine learning model on image data captured by a plurality of cameras, the machine learning model comprising a plurality of layers; apply a non-linear mapping function to output of one layer of the plurality of layers to generate depth data; and train the machine learning model based on the depth data to generate a trained machine learning model.

In another example, this disclosure describes a system comprising: means for executing a machine learning model on image data captured by a plurality of cameras, the machine learning model comprising a plurality of layers; means for applying a non-linear mapping function to output of one layer of the plurality of layers to generate depth data; and means for training the machine learning model based on the depth data to generate a trained machine learning model.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example vehicle according to one to more aspects of this disclosure.

FIG. 2 is a conceptual diagram illustrating an example architecture of a system for providing a depth prediction based on image data from a plurality of cameras according to one or more aspects of this disclosure.

FIG. 3 is a conceptual diagram illustrating an example of a decoder side architecture associated with a single camera of a plurality of cameras according to one or more aspects of this disclosure.

FIG. 4 is a conceptual diagram illustrating an example neural network according to one or more aspects of this disclosure.

FIG. 5 is a graphical diagram illustrating example non-linear functions according to one or more aspects of this disclosure.

FIG. 6 is a graphical diagram illustrating an example of a distribution of depth according to one or more aspects of this disclosure.

FIG. 7 is a graphical diagram illustrating examples of non-linear functions having different values of alpha.

FIG. 8 is a flow diagram illustrating depth prediction techniques according to one or more aspects of this disclosure.

### DETAILED DESCRIPTION

With conventional stereo camera systems utilizing a machine learning model, such as a neural network, the neural network outputs disparity data between the two cameras and disparity data is then converted to depth data. For example, depth can be determined based on point correspondences between images captured by each of the two cameras using triangulation. Disparity may be a displacement of a point between images captured by the two cameras. However, vehicles and/or robots may have multi-camera setups rather than stereo camera setups. Unlike a conventional stereo camera system, a multi-camera setup may include a plurality of cameras, each having a different field of view. Some or all of the plurality of cameras may have overlapping fields of view with one or more other cameras of the plurality of cameras. As such, in a multi-camera setup, disparity data is not necessarily correlated to depth data.

According to the techniques of this disclosure, rather than outputting disparity data and converting the disparity data to depth data, a system may apply a non-linear mapping function to an output of a layer of the machine learning model (e.g., to an output of an output layer, or a to an output of middle layer) to generate depth data and then use the depth data to train the machine learning model to generate a trained machine learning model which may be used to operate a vehicle, a robot, an augmented reality device, a virtual reality device, or the like.

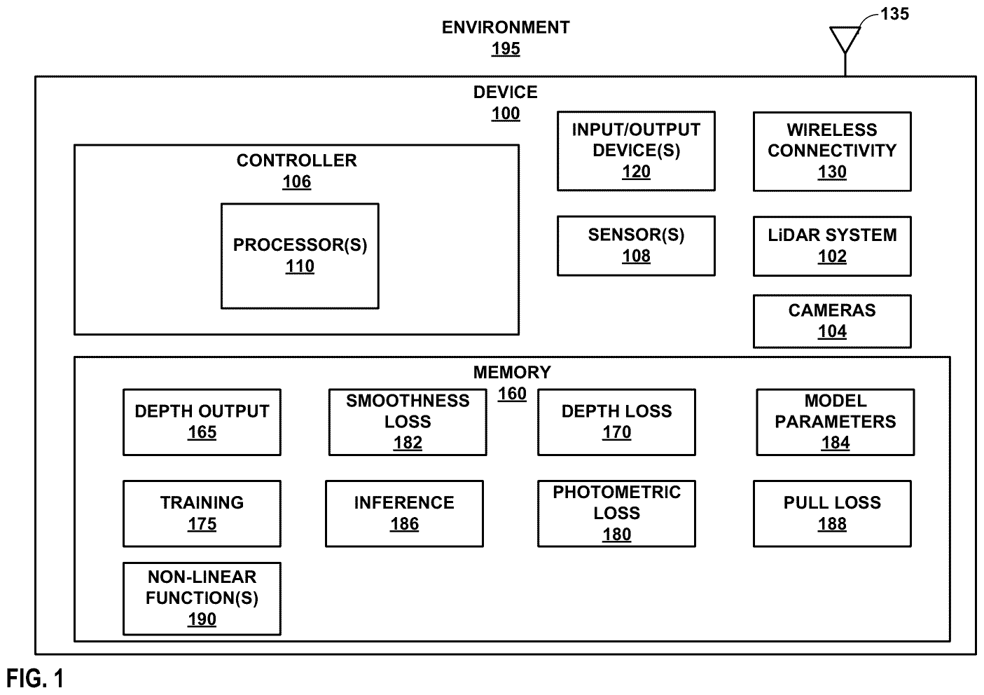

FIG. 1 is a block diagram illustrating an example vehicle according to one to more aspects of this disclosure. Device 100 may include an autonomous driving vehicle, an assisted driving vehicle (e.g., a vehicle having an advanced driver-assistance system (ADAS)), a robot, an augmented reality system, a virtual reality system, or the like. In some examples, device 100 may be referred to as an ego vehicle. In some examples, device 100 may include more components or fewer components than shown in FIG. 1.

Device 100 may include LiDAR system 102, cameras 104, controller 106, one or more sensor(s) 108, input/output device(s) 120, wireless connectivity component 130, and memory 160. LiDAR system 102 may include one or more light emitters and one or more light sensors. LiDAR system 102 may be deployed in or about device 100. For example, LiDAR system 102 may be mounted on a roof of device 100, in bumpers of device 100, and/or in other locations of device 100. LiDAR system 102 may be configured to emit light pulses and sense the light pulses reflected off of objects in the environment of device 100. LiDAR system 102 (and/or processor(s) 110) may determine a distance to such objects based on the time between the emission of a light pulse and the sensing of the reflection of the light pulse. LiDAR system 102 may emit such pulses in a 360 degree field around device 100 so as to detect objects within the 360 degree field, such as objects in front of, behind, or beside device 100. While described herein as including LiDAR system 102, it should be understood that another distance or depth sensing system may be used in place of LiDAR system 102.

Dense (or sparse) depth estimation may be relatively important to a variety of applications, such as autonomous driving, assistive robotics, augmented reality, virtual reality scene composition, image editing, and/or the like. For example, in an autonomous driving scenario, depth estimation may provide an estimated distance from one vehicle (e.g., first vehicle) to another (e.g., second vehicle), which may be important to operational systems of the first vehicle, for instance, acceleration, braking, steering, etc.

Depth estimation may be implemented through leveraging any of a number of different principles, such as principles associated with cameras 104. For example, multi-camera information, or the like, may be used for depth estimation.

Cameras 104 may multiple camera sensors (also referred to a cameras) located in positions in or on the vehicle, such as in or on mirrors, bumpers, and/or other locations device 100. Cameras 104 may be configured to capture video or image data in an environment 195 around device 100. Controller 106 may use information from cameras 104 for determining depth information of objects that may be in a field of view of one or more of cameras 104. In some examples, cameras 104 may include or be referred to as a multi-view camera system.

Different techniques for depth estimation or prediction exist. For example, depth estimation may be performed based on calibrated stereo images, multi-view stereo images, learning from monocular videos (e.g., Structure from Motion (SfM)), or the like.

When using a calibrated stereo setup, the most traditional way to perform this task is with the use of a known baseline. A system may perform a disparity calculation between pixels of two corresponding images captured by a pair of horizontally offset cameras. The system may calculate depth directly from the results of the disparity calculation by knowing a focal length as well as the stereo setup baseline (e.g., a distance between the two cameras). As a result, traditionally, deep learning networks working on stereo camera input images may predict disparity first and then covert disparity to depth to predict the depth.

Depth estimation or prediction can be performed in a monocular or multi-camera setup in few different ways. With self-supervision, a system may use a temporal axis to infer depth. With this technique, the system may need reliable pose information between image frames either from a positioning engine or a pose estimation network. The system may use joint learning of depth and ego-motion (e.g., motion of a vehicle or robot including the system) using self-supervision. The use of self-supervision may leverage SfM (Structure-from-Motion) principles to perform view synthesis as the self-supervision signal. The use of self-supervision may also eliminate the need for depth ground truth which may not be easy to construct. Moreover, the abundance of video data makes self-supervision an attractive option.

With full-supervision, a system may learn a mapping from images to dense depth maps. However, it is very difficult to acquire real world high-quality depth annotations.

With partial-supervision, the system may rely mainly on self-supervision while applying full-supervision to a small set of pixels. Such a technique may help to resolve the issue of scale ambiguity in self-supervision.

For a vehicle with a single (front-facing) camera, depth estimation using data from the single camera may not be sufficient for full scene understanding. For example, there would be no information regarding the sides and back of the ego vehicle. However, autonomous vehicles may require a representation of the surrounding environment to successfully navigate or maneuver, e.g., for obstacle avoidance.

A multi-camera setup within or on a vehicle is ubiquitous on modern autonomous vehicles. The use of a plurality of cameras, such as cameras 104, may capture the full surrounding environment of the ego vehicle. Multi-camera depth estimation may therefore be particularly useful for building a full 3D representation of the surrounding environment.

If a system were using a calibrated stereo technique, predicting disparity might provide some insight, as the relationship between disparity and depth is meaningful because there may be a well-defined baseline. In the case of other techniques, such as monocular, uncalibrated stereo, multi-view, etc., the relationship between disparity and depth is usually weak. This weak relationship may cause an inherent scale ambiguity.

Irrespective of the technique being used, depth is usually the information being ultimately sought and predicting disparity has been a legacy trend because most depth estimation efforts started with using a stereo technique. Additionally, because, in such legacy cases, the output of the neural network is disparity, the system may need to employ a floating-point division (which may be costly to implement in hardware) to derive depth. The system may also need to convert the disparity data into a form more easily visualized or reasoned with.

According to the techniques of this disclosure, the output of a machine learning model, such as a neural network, may be interpreted as depth information directly. In other words, the techniques would not take disparity output from a neural network and convert the disparity to depth.

If a system, e.g., a machine learning model, were to normalize depth to a value in the range of [0, 1] and multiply the depth by (max_depth−min_depth) and add min_depth, which may be a linear function, the results may be less than desired. max_depth may represent a maximum depth in a scene or image and min_depth may represent a minimum depth in a scene or image. For example, weights of the neural network may saturate due to the nature of sigmoid at the output layer. For example, to get to a value of to 1, the input value must get very large.

Controller 106 may be an autonomous or assisted driving controller (e.g., an ADAS) configured to control operation of device 100. For example, controller 106 may control acceleration, braking, and/or navigation of device 100 through the environment surrounding device 100. Controller 106 may include one or more processors, e.g., processor(s) 110. Processor(s) may include one or more central processing units (CPUs), such as single-core or multi-core CPUs, graphics processing units (GPUS), digital signal processor (DSPs), neural processing unit (NPUs), multimedia processing units, and/or the like. Instructions executed by processor(s) 110 may be loaded, for example, from memory 160 and may cause processor(s) 110 to perform the operations attributed to processor(s) in this disclosure. In some examples, one or more of processor(s) 110 may be based on an ARM or RISC-V instruction set.

An NPU is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processor(s) 110 may be configured to accelerate the performance of common machine learning tasks, such as image classification, machine translation, object detection, and various other tasks. In some examples, a plurality of processor(s) 110 may be instantiated on a single chip, such as a system on a chip (SoC), while in other examples one or more of processor(s) 110 may be part of a dedicated machine learning accelerator device.

In some examples, one or more of processor(s) 110 may be optimized for training or inference, or in some cases configured to balance performance between both. For processor(s) 110 that are capable of performing both training and inference, the two tasks may still generally be performed independently.

In some examples, processor(s) 110 designed to accelerate training are generally configured to accelerate the optimization of new models, which is a highly compute-intensive operation that involves inputting an existing dataset (often labeled or tagged), iterating over the dataset, and then adjusting model parameters 184, such as weights and biases, in order to improve model performance. Generally, optimizing based on a wrong prediction involves propagating back through the layers of the model and determining gradients to reduce the prediction error. In some examples, some or all of the adjustment of model parameters 184 may be performed outside of device 100, such is in a cloud computing environment.

In some examples, processor(s) 110 designed to accelerate inference are generally configured to operate on complete models. Such processor(s) 110 may thus be configured to input a new piece of data and rapidly process the data through an already trained model to generate a model output (e.g., an inference).

In some examples, processor(s) 110 may operate on predictive models such as artificial neural networks (ANNs) or random forests (RFs). An ANN may include a hardware and/or a software component that includes a number of connected nodes (e.g., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge may be associated with one or more node weights that determine how the signal is processed and transmitted. During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

A convolutional neural network (CNN) is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

The term “loss function” refers to a function that impacts how a machine learning model is trained in a supervised learning model. Specifically, during each training iteration, the output of the model is compared to the known annotation information in the training data. The loss function provides a value for how close the predicted annotation data is to the actual annotation data. After computing the loss function, the parameters of the model are updated accordingly and a new set of predictions are made during the next iteration.

In some aspects, wireless connectivity 130 component may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity 130 processing component is further connected to one or more antennas 135.

Processor(s) 110 may also include one or more sensor processing units associated with LiDAR system 102, cameras 104, and/or sensor(s) 108. For example, processor(s) 110 may include one or more image signal processors associated with cameras 104 and/or sensor(s) 108, and/or a navigation processor associated with sensor(s) 108, which may include satellite-based positioning system components (e.g., GPS or GLONASS) as well as inertial positioning system components.

Device 100 may also include one or more input and/or output devices 120, such as screens, touch-sensitive surfaces (including touch-sensitive displays), physical buttons, speakers, microphones, and the like.

Device 100 also includes memory 160, which is representative of one or more static and/or dynamic memories, such as a dynamic random access memory, a flash-based static memory, and the like. In this example, memory 160 includes computer-executable components, which may be executed by one or more of the aforementioned components of device 100.

Examples of memory 160 include random access memory (RAM), read-only memory (ROM), or a hard disk. Examples of memory 160 include solid state memory and a hard disk drive. In some examples, memory 160 is used to store computer-readable, computer-executable software including instructions that, when executed, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 160 store information in the form of a logical state.

In particular, in this example, memory 160 includes model parameters 184 (e.g., weights, biases, and other machine learning model parameters 184). One or more of the depicted components, as well as others not depicted, may be configured to perform various aspects of the techniques described herein.

Generally, device 100 and/or components thereof may be configured to perform the techniques described herein. Note that device 100 of FIG. 1 is just one example, and in other examples, alternative device 100 with more, fewer, and/or different components may be used.

In some aspects, cameras 104 and/or sensor(s) 108 may include optical instruments (e.g., an image sensor, camera, etc.) for recording or capturing images, which may be stored locally, transmitted to another location, etc. For example, an image sensor may capture visual information using one or more photosensitive elements that may be tuned for sensitivity to a visible spectrum of electromagnetic radiation. The resolution of such visual information may be measured in pixels, where each pixel may relate an independent piece of captured information. In some cases, each pixel may thus correspond to one component of, for example, a two-dimensional (2D) Fourier transform of an image. Computation methods may use pixel information to reconstruct images captured by the device. In a camera, an image sensors may convert light incident on a camera lens into an analog or digital signal. An electronic device may then display an image on a display panel based on the digital signal. Image sensors are commonly mounted on electronics such as smartphones, tablet personal computers (PCs), laptop PCs, and wearable devices.

In some aspects, sensor(s) 108 may include direct depth sensing sensors, which may function to determine a depth of or distance to objects within the environment surrounding device 100. Data from such dept sensing sensors may be used to supplement the depth map generation techniques discussed herein.

Input/output device(s) 120 (e.g., which may include an I/O controller) may manage input and output signals for device 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processor(s) 110). In some cases, a user may interact with a device via input/output device(s) 120 or via hardware components controlled by input/output device(s) 120.

In one aspect, memory 160 includes depth output 165 (which may include a depth map), depth loss 170, training information 175, photometric loss 180, smoothness loss 182, model parameters 184, inference 186, pull loss 188, and non-linear function(s) 190.

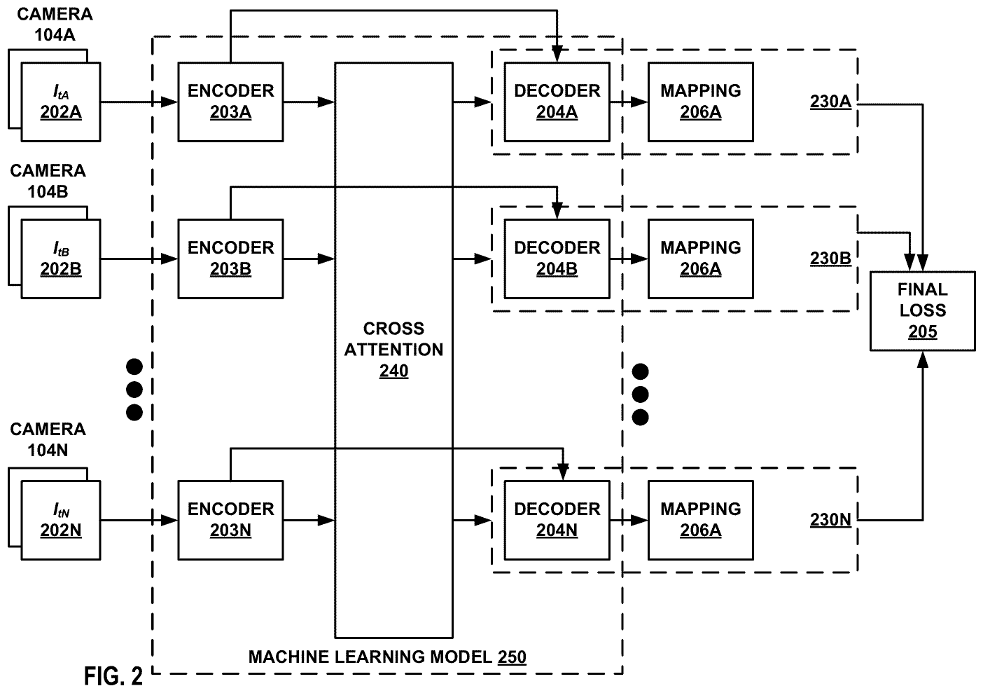

FIG. 2 is a conceptual diagram illustrating an example architecture of a system for providing a depth prediction based on image data from a plurality of cameras according to one or more aspects of this disclosure. Each of image data 202A, 202B through 202N (collectively image data 202) represent image data captured by a respective camera of cameras 104. Image data 202A may include a frame of image data captured by a first camera of cameras 104 at time t(Iₜ), time t−1, time t−2, and so on. Image data 202B may include a frame of image data captured by a second camera of cameras 104 at time t (Iₜ), time t−1, time t−2, and so on. Image data 202N may include a frame of image data captured by an nth camera of cameras 104 at time t (Iₜ), time t−1, time t−2, and so on.

Image data 202 may be input to a machine learning model 250. Machine learning model 250 may include encoders 203A-203N, cross attention function 240 and/or decoders 204A-204N. In some examples, rather than a single machine learning model 250 as shown, there may be separate machine learning models, such as a respective machine learning model associated with each respective image data (e.g., image data 202A, image data 202B, image data 202N) of image data 202. Cross attenuation unit 240 may be configured to allow features in images captured from different cameras to interact and cooperate to improve the overall quality of the features extracted from images captured across all of cameras 104.

Machine learning model 250 processes image data 202 and generates a depth output (\hat{D}ₜ) to which a mapping, mapping units 206A-206N (collectively mapping units 206) is applied, e.g., f(\hat{D}ₜ). Output (\hat{D}ₜ) may take different forms, such as a depth map indicating the estimated depth of each pixel directly. Mapping units 206 may apply a non-linear mapping function to the output of machine learning model 250 (\hat{D}ₜ). While discussed with respect to FIG. 2 as being applied to the output of machine learning model 250, in some examples, mapping 206 may be applied as part of the machine learning model 250 itself, for example, as an output layer of machine learning model 250. Decoder side architectures 230A, 230B through 230N are shown in an abbreviated form for simplicity purposes. Each of decoder side architectures 230 may be associated with a respective camera of cameras 104 such that a respective decoder side architecture 230 may receive encoded image data 202 associated with its respective camera. For example, decoder side architecture 230A may be associated with camera 104A, decoder side architecture 230B may be associated with camera 104B, and so on.

Each of the outputs of decoder side architectures 230 may be input to a final loss unit 205. Final loss unit 205 may provide a final loss to generate depth data, such as a depth estimation. In some examples, this depth estimation may be in the form of a depth map.

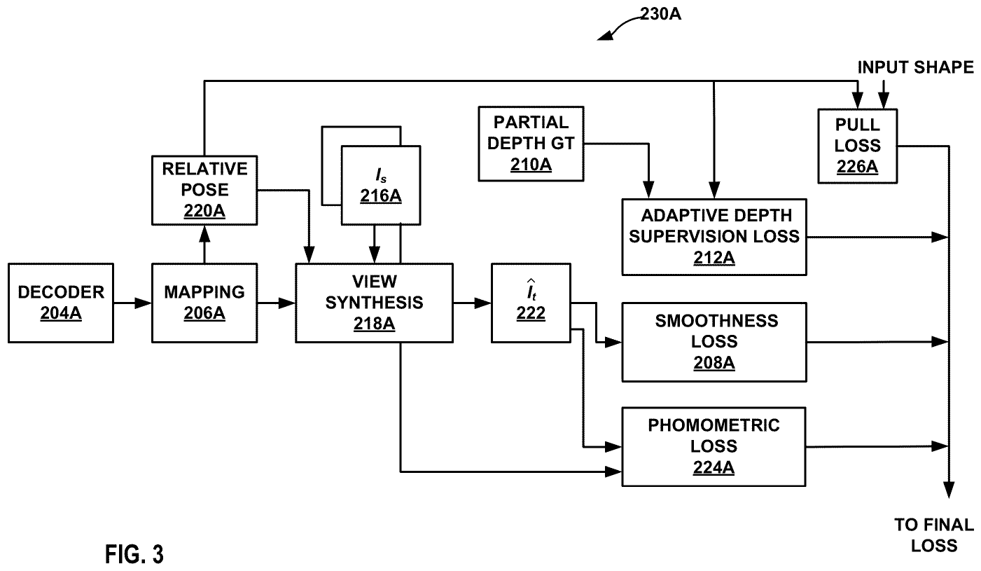

FIG. 3 is a conceptual diagram illustrating an example of a decoder side architecture associated with a single camera of a plurality of cameras according to one or more aspects of this disclosure. In the example of FIG. 3, decoder side architecture 230A is depicted which is associated with camera 104A. Each of decoder side architectures 230B-230N may be similar to decoder side architecture 230A.

As discussed with respect to FIG. 2, output of decoder 204A, which may be an output of machine learning model 250 may include a depth output (\hat{D}ₜ). Mapping unit 204A may apply a non-linear mapping function f(\hat{D}ₜ) to the depth output (\hat{D}ₜ) to generate a more accurate depth estimation than (\hat{D}ₜ).

The output of mapping unit 204A may be input to view synthesis unit 218A. View synthesis unit 218 further takes as inputs one or more context frames (Is) 216A and a pose estimate from relative pose unit 220A and generates a reconstructed subject frame ( [symbol] ) 222A. For example, view synthesis unit 218A may perform an interpolation, such as bilinear interpolation, based on a relative pose from relative pose unit 220A and using the output of mapping unit 206A.

Relative pose unit 220 is generally configured to determine a relative pose. Such a relative pose may be determined based on data such as global positioning satellite (GPS) data. Such a relative pose may change from frame to frame of image data 204A, for example, when device 100 is in motion.

Reconstructed subject frame ( [symbol] ) 222A may be input to smoothness loss unit 208, which determines a loss based on, for example, the “smoothness” of reconstructed subject frame ( [symbol] ) 222A or the output of mapping unit 206A. In one aspect, the smoothness may be measured by the gradients (or average gradient) between adjacent pixels across the reconstructed subject frame ( [symbol] ) 222A or the output of mapping unit 206A. For example, an image of a simple scene having few objects may have a very smooth depth map, whereas an image of a complex scene with many objects may have a less smooth depth map, as the gradient between depths of adjacent pixels changes frequently and significantly to reflect the many objects.

Smoothness loss unit 208A provides a smoothness loss component to final loss unit 205. Though not depicted in FIG. 3, the smoothness loss component may be associated with a hyperparameter (e.g., a weight) in final loss unit 205, which may alter the influence of the smoothness loss on final loss unit 205.

Context frames 216A may generally be frames near to the subject frame 202A. For example, context frames 216A may be some number of frames or time steps on either size of subject frame 202A, such as t+/−1 (adjacent frames), t+/−2 (non-adjacent frames), or the like. Though these examples are symmetric about subject frame 202A, context frames 216A could be non-symmetrically located, such as t−1 and t+3.

Reconstructed subject frame 222A may be compared against subject frame 202A by a photometric loss unit 224A to generate a photometric loss, which is another component used by final loss unit 205. As discussed above, though not depicted in the figure, the photometric loss component may be associated with a hyperparameter (e.g., a weight) in final loss unit 205, which changes the influence of the photometric loss on final loss unit 205.

The output of relative pose unit 220A may be input to adaptive depth supervision loss unit 212A, which takes as a further input a partial depth ground truth 210A for subject frame 202A, in order to generate an adaptive depth supervision loss. In some aspects, adaptive depth supervision loss function 212A only has or uses estimated depth ground truth values for a portion of the scene in subject frame 202, thus this step may be referred to as a “partial supervision”. In other words, while machine learning model 250 provides a depth output for each pixel in subject frame 202A, partial depth ground truth 210A may only include estimated ground truth values for a subset of the pixels in subject frame 202A.

Partial depth ground truth 210A be determined through any of various different techniques. In one aspect, a sensor fusion function (or module) uses one or more sensors to directly sense depth information from a portion of a subject frame.

Pull loss unit 226A may calculate pull loss, representing a degree to which corners of an object are accurately joined in a depth map. Pull loss unit 226A may receive data representing input shapes to calculate the pull loss. Pull loss unit 226A may provide the pull loss to final loss unit 205. The pull loss may act as a prior value for depth values to get the depth values to within a predetermined set, which may help with areas for which data may not be readily understandable, such as open sky. As discussed above, though not depicted in the figure, the pull loss component may be associated with a hyperparameter (e.g., a weight) in final loss unit 205, which changes the influence of the pull loss on final loss unit 205.

In an aspect, the final or total (multi-component) loss generated by final loss unit 205 (which may be generated based a smoothness loss generated by a smoothness loss unit 208A, an adaptive depth supervision loss generated by an adaptive depth supervision loss unit 212A, a photometric loss generated by photometric loss unit 224A, and/or a pull loss generated by pull loss unit 226A) is used to update or refine machine learning model 250. For example, using gradient descent and/or backpropagation, one or more parameters of depth model 204 may be refined or updated based on the total loss generated for a given subject frame 202.

In aspects, this updating may be performed independently and/or sequentially for a set of subject frames 202A (e.g., using stochastic gradient descent to sequentially update the parameters of the machine learning model 250 based on each subject frame 202A) and/or in based on batches of subject frames 202A (e.g., using batch gradient descent).

Using the architecture of FIGS. 2 and 3, machine learning model 250 thereby learns to generate improved and more accurate depth estimations. During runtime inferencing, trained model 250 may be used to generate a depth output (\hat{D}ₜ) for an input subject frame, e.g., subject frame 202A. This depth output can then be used for a variety of purposes, such as autonomous driving and/or driving assist, as discussed above. In some aspects, at runtime, machine learning model 250 may be used without consideration or use of other aspects of the architectures of FIGS. 2 and 3, such as context frames, view synthesis units, relative pose units, reconstructed subject frames, photometric loss units, smoothness loss units, adaptive depth supervision loss units, pull loss units, and/or final loss units.

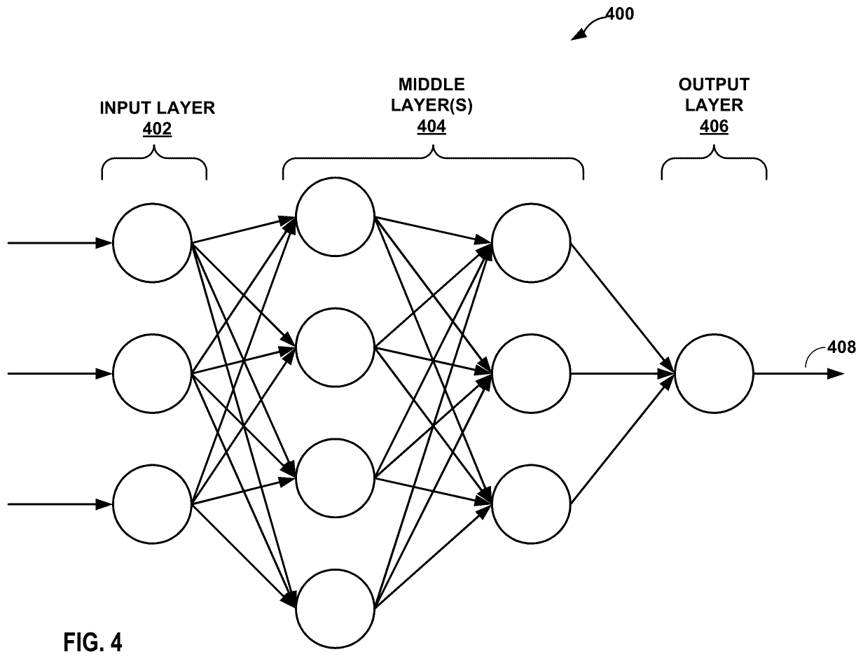

FIG. 4 is a conceptual diagram illustrating an example neural network according to one or more aspects of this disclosure. Neural network 400 may be an example of machine learning model 250 or parts thereof.

Neural network 400 may include input layer 402, one or more middle layer(s) 404, and output layer 406. Input layer 402 may represent inputs into neural network 400. For example, such inputs may include image data 202. Middle layer(s) 404, which may also be referred to as hidden layer(s), may apply various functions to data provided by an immediately previous layer. Output layer 406 may apply a function to output of the last layer of middle layer(s) 404 and may output an estimation or prediction from neural network 400.

Each of the input data is input to each node of the first layer of middle layer(s) 402. Each of the nodes of the middle layer(s) may apply a weight to input data to the node as part of providing the function of the respective layer of middle layer(s) 402. For example, a node may apply a weight in accordance with an activation function which a given layer may include. When neural network 400 is being trained (e.g., using the architectures of FIGS. 2 and 3), the weights of the nodes may be adjusted for example, based on a final loss determined by final loss unit 205 (and/or any of the other losses discussed with respect to FIG. 3. As such, a relationship between input image data and a depth estimation may be adjusted to improve the depth estimation.

Iₜ should be noted that the number of middle layers, inputs, outputs, and nodes of neural network 400 are provided as merely an example. Neural network 400 may include any number of middle layers, inputs, outputs, and/or nodes.

As discussed above, in some examples, mapping units 206 may apply non-linear mapping function(s) on the output of machine learning model 250. For example, mapping may be performed on output 408 of neural network 400. In other examples, mapping units 206 may be part of output layer 406. In other words, the mapping may be performed as a function of output layer 406. For example, output layer 406 may perform the non-linear mapping function on output from a last layer of middle layer(s) 404. In such an example, mapping units 206 would be part of neural network 400 and need not to separately exist or to apply a non-linear mapping function on output 408.

In some examples, neural network 400 may apply one or more activation functions on image data 202. An activation function may be a function applied by node(s) of a neural network to calculate the output of the node(s). In some examples, all of middle layer(s) 404 may apply an activation function on data from an immediate previous layer. In some examples, output layer 406 may apply an activation function. For example, different experiments were performed using activation functions focused, mainly on two locations: 1) all the middle layer(s) 404; and 2) output layer 406. For example, potential activation functions of rectified linear unit (ReLU), parametric rectified linear unit (PReLU), and exponential linear unit (ELU) were tested for all middle layer(s) 404. Potential activation functions of ReLU, PRELU, ELU, Sigmoid, a x Sigmoid (to avoid pushing values to +infinity to get max_depth), and Softplus were tested for output layer 406. The experiments indicated that in-place ELU for the output layer 406 achieves higher accuracy and better training stability than the other activation functions. For middle layer(s) 404, PRELU performed better than the other tested alternatives.

The output of machine learning model 250 may be in the range of [0, 1] and this output can be uniform in that range. However, there is a different level of accuracy for different depth values and relative error may be used as a metric. As a result, the output of the machine learning model 250 may not necessarily be mapped linearly to the output range of [min_depth, max_depth]. Indeed, it may be desirable to map the output of machine learning model 250 to the range of [min_depth, max_depth] in a non-linear manner.

Potential mappings of the output of the machine learning model 250 to an output range are now discussed. In the example of an autonomous driving scenario, it may be desirable to select a non-linear function such that the output of the non-linear function would be very accurate within the first 20 meters from the ego vehicle. For example, it may be more important in an autonomous driving scenario that depth information relating to an object that is relatively close to the ego vehicle is precise than depth information relating to an object that is relatively far from the ego vehicle.

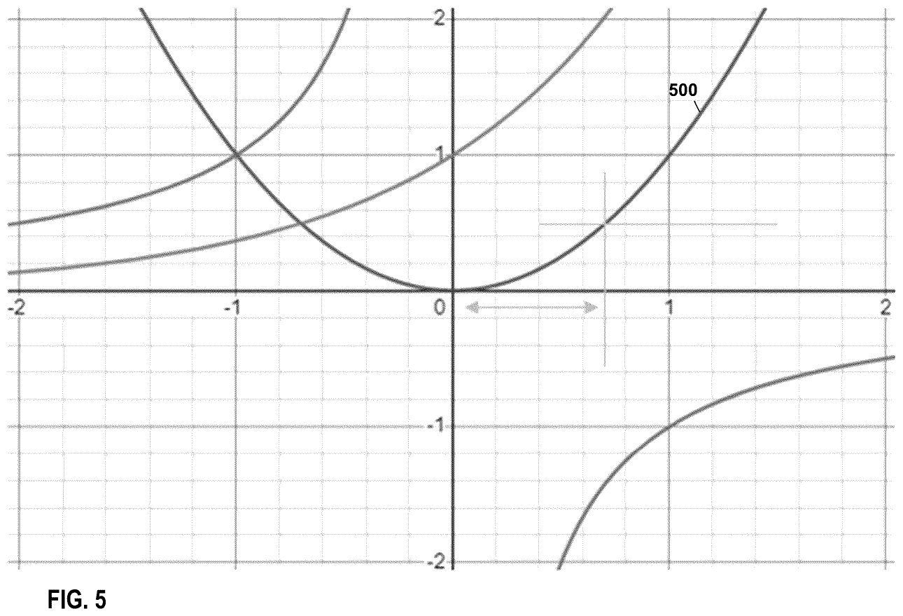

FIG. 5 is a graphical diagram illustrating example non-linear functions according to one or more aspects of this disclosure. In the example of FIG. 5, the x-axis represents an input depth (e.g., Dt which is input to mapping unit 206A of FIG. 2), which may be in a range of 0 to 1. The y-axis represents an output depth (e.g., in a range of min_depth to max_depth) of the non-linear function (e.g., the output of mapping unit 206A). As it may be desirable to be more accurate with depth information associated with objects relatively close to device 100, a non-linear mapping function may be selected to devote more of an x-range to a bottom half of a y-range as there may be more pixels with lower depth values and the accuracy metric may be more sensitive to the errors in small depth values. To achieve this, a number of possible functions may be used, such as a log (exponentiation) function, a square root (squared) function, a negative inverse (negative inverse) function, etc. As can be seen in FIG. 5, function 500 approximately 0.7 units of the x-axis are devoted to the first 0.5 units of the y-axis.

For example, a non-linear mapping function may be selected such that a slope of the non-linear mapping function is based on a loss function, an input depth of the non-linear mapping function, and/or a probability distribution of an output depth of the non-linear mapping function. For example, the non-linear mapping function may be associated with a mean absolute relative error loss function and the slope of the non-linear mapping function may increase with the input depth of the non-linear mapping function and/or decrease with a higher probability density of the output depth of the non-linear mapping function.

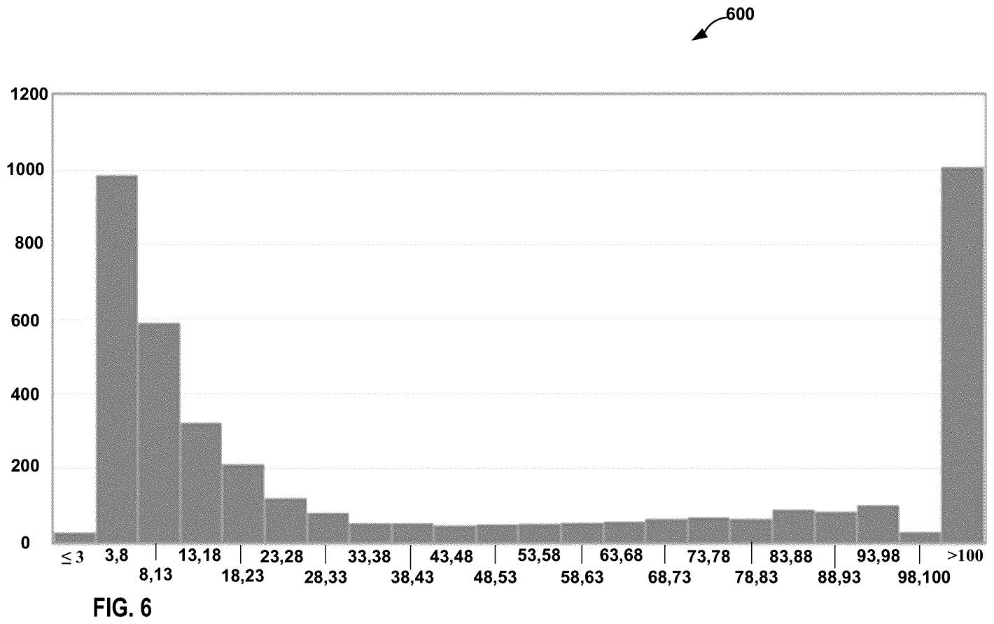

FIG. 6 is a graphical diagram illustrating an example of a distribution of depth according to one or more aspects of this disclosure. The x-axis of FIG. 6 represents depth of pixels of image data 204 and the y-axis of FIG. 6 represents a number of pixels of image data 204 within the depth represented by the x-axis. As can be seen there are a large number of points in the range of 3-8 m with a smaller number of points in the immediate succeeding ranges and then another a large number of points in the range of greater than 100 m (e.g., sky, horizon, etc.). The distribution of points of the pixel data may vary greatly depending on the environment in which device 100 is operating. For example, pixel data in an urban environment may vary significantly from pixel data in a rural environment.

A non-linear function can be derived to meet any data or error of concern. For example, in the example of an ego-vehicle, for highway driving objects being relatively spaced apart from each other, one non-linear function may be appropriate, while a different non-linear function may be appropriate for city driving, where objects may be more closely spaced. As such a system, such as device 100 may select or determine a non-linear mapping function based on an environment in which device 100 is operating. For example, device 100 may include a plurality of non-linear mapping functions 162, from which device 100 may select to use for mapping 204 based on the surrounding environment detected by device 100 through data from LiDAR system 102, cameras 104, and/or sensor(s) 108, the input of a user, or the like.

A large class of strictly monotonic functions may be used in the mapping. Such a mapping may map part of the curve to a reasonable range around 0, for example, the range of [0,1]. A simple normalization may be used. Some of the potential non-linear mapping functions may work better than others depending on the exact distribution of pixel depths. For example, a square root function might work better than a log function.

In some examples, the optimal non-linear mapping function that may be used to map the output of the depth estimation neural network to the output range can be derived either theoretically or empirically. Both theoretical and empirical techniques were used to determine this function as set forth in this disclosure.

In terms of theorical techniques, both a discretized approach and a calculus-based approach were analyzed. For example, a formal technique of determining this mapping function may include using calculus of variations and using numerical techniques with a discretized range. Such a technique may result in a look-up based technique that may include curve fitting to the discretized version.

For example, one may begin with a proxy optimization function which is configured to keep the error characteristics uniform by equalizing the amount of error in each epsilon interval. This may assure any small perturbation to the input results in a small perturbation to the output, rather than a small perturbation in the input resulting in a large perturbation in the output.

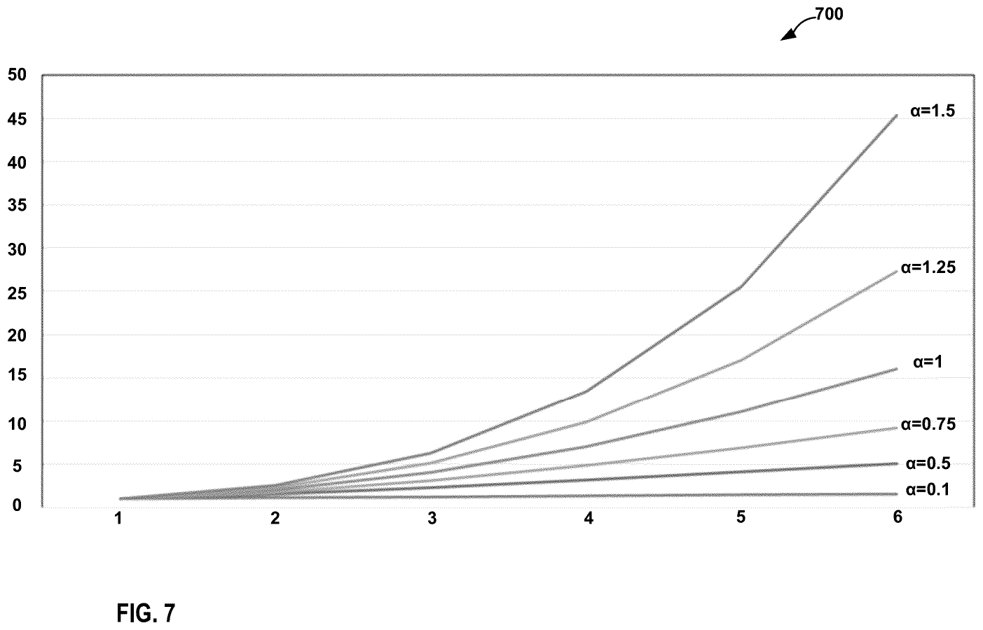

FIG. 7 is a graphical diagram illustrating examples of non-linear functions having different values of alpha. A discretized analysis is now discussed. Applying a discretized analysis to the output range (e.g., of output 408 of FIG. 4), one may assume a min_depth of 1.0 and a uniform distribution of pixel depth values. As such, the sequence, which may be a discrete representation of output 4080 comes out to something of the nature of the following. For alpha equals to one, the sequence may be 1, 2, 4, 7, (11), (16), . . . . Such a sequence may be referred to as a lazy caterer's sequence (a quadratic form) which describes the maximum number of pieces of a disk (e.g., a pancake or pizza is usually used to describe the situation) that can be made with a given number of straight cuts. For other values of alpha, the sequence may be exponential (an=αan−1+ (n−1)α+1). Thus, depending on the value of alpha, a different shape may be defined for this function as shown in FIG. 7.

If one were to assume a non-uniform distribution of depth values, for example, a distribution of the form

$${a ( \frac{1}{2} )}^{x} ,$$

then the sequence may be 1, 2, 6, 30, 270, (4590), . . . .

The growth, for example, may be in the form of xx. For example, for alpha equals one:

The nth term of the sequence is given by

$$T ( n ) = {n}^{n} + n$$

Now, Using these relation, we can easily find the series

$$T ( 1 ) = {1}^{1} + 1 = 2 \\ T ( 2 ) = {2}^{2} + 2 = 6 \\ T ( 3 ) = {3}^{3} + 3 = 30 \\ T ( 4 ) = {4}^{4} + 4 = 260 \\ Similarly , \\ T ( 5 ) = {5}^{5} + 5 = 3130$$

For other values of alpha, discretized math may become intractable.

Using a calculus of variations to derive the mapping function is now discussed.

As discussed above, various functions were empirically tested including a log function, a square root function, and an x^{1/3} function.

For example, the non-linear mapping function which is applied by mapping 206 may be y=ƒ(x) that is defined from ƒ:[0, 1]→[dₘᵢₙ, dₘₐₓ]. The [0,1] may be the output of decoders 204 of machine learning model 250. Decoders 204 may output values from 0 to 1, or −1 to 1, or −0.5 to 0.5, which are typically within a small range, whereas dₘᵢₙ, dₘₐₓ are more like 1 to 100 m, 1 to 300 m, etc.

The non-linear mapping function f may be a monotonically non-decreasing function (non-decreasing vs increasing to capture the aspect that the function may be flat in some ranges). Some examples of the slope of the function based on different considerations are as follows. For a general cost function providing same penalty for all depths,

$$\frac{dy}{dx} = η ,$$

where η is a constant. The function y(x) in this case will be linear. However, if the cost is of the form

$$C ( y , {y}^{*} ) = \frac{\vert y - {y}^{*} \vert}{{y}^{*}} ,$$

where error in larger depths are down weighted (due to y* in denominator). In this example, y*is a true depth from a ground truth, such as partial depth ground truth 210A. An example slope can be of the form. Notice that steepness increases with depth below

$$\frac{dy}{dx} = η y$$

In addition, if based on a scenario where the probability distribution of ground truth data is provided, p(⋅), then some exemplary slopes of the non-linear mapping function are provided below. The slope is lower for cases where the p (y) is high, or higher density

$$\frac{dy}{dx} = \frac{η y}{p ( y )} or \\ \frac{dy}{dx} = η \sqrt{\frac{y}{p ( y )}}$$

Further if the cost function is different, for example,

$$C ( y , {y}^{*} ) = \frac{\vert y - {y}^{*} \vert}{{y}^{* 2}} ,$$

which further down weights the impact of errors in farther distances, additional possibilities may arise as set forth below. In such examples, the slope increases much more steeply with distance.

$$\frac{dy}{dx} = η {y}^{2} or \\ \frac{dy}{dx} = \frac{η {y}^{2}}{p ( y )} , etc$$

From the slope, the actual non-linear mapping function ƒ(x) can be obtained via numerical integration, or solved in closed form. The above are just some exemplary implementations, but others are possible with, for example, a general theme of steepness of the non-linear mapping function is dependent on the cost function for depth, and the probability distribution of depth.

For example, for example, if the output of Qdepth is x, it may be desirable to find the function y=ƒ(x), ƒ:R [symbol] → [symbol] to be optimized for a specific loss function [symbol] . A consideration for optimization may be that for a small perturbation in the input x, there is only a small perturbation for the loss, under various considerations, such as an average loss, a scaled loss with respect to depth distribution, a uniform loss for all x, etc.

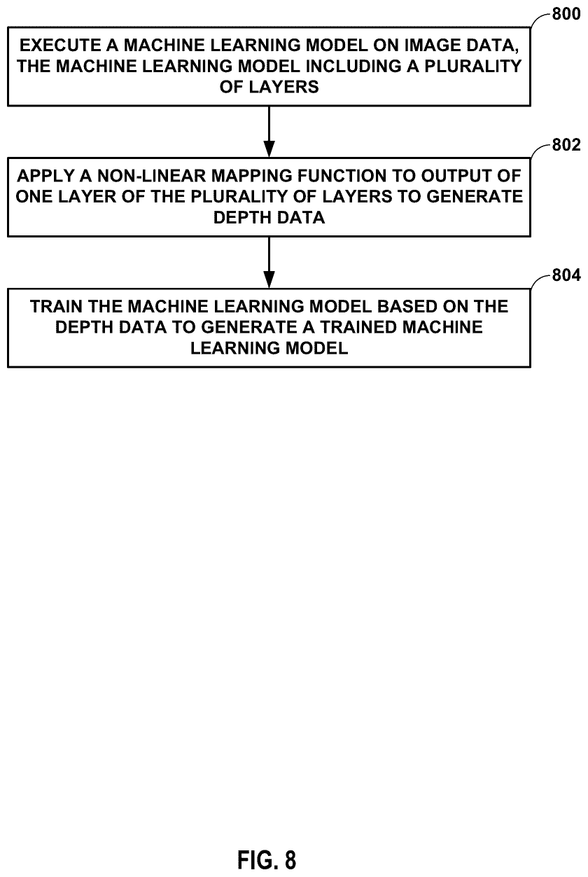

FIG. 8 is a flow diagram illustrating depth prediction techniques according to one or more aspects of this disclosure. Processor(s) 110 may execute machine learning model 250 on image data 202, machine learning model 250 including a plurality of layers (e.g., input layer 402, middle layer(s) 404, and output layer 406) (800). For example, processor(s) 110 may execute machine learning model 250 using as input, image data 202 from cameras 104.

Processor(s) 110 may apply a non-linear mapping function to output of one layer of the plurality of layers to generate depth data (802). For example, processor(s) 110 may apply one of non-linear mapping functions 190 to either the output of machine learning model 250 (e.g., the output of output layer 406) or to the output of a last layer of middle layer(s) 404 (in which case the non-linear mapping function is applied at output layer 406).

Processor(s) 110 may train machine learning model 250 based on the depth data to generate a trained machine learning model 250. For example, processor(s) 110 may train machine learning model 250 using the depth data to better estimate depth. In the course of training machine learning model 250, processor(s) 110 may change model parameters 184, such as weights to be applied by nodes of machine learning model 250, to improve depth estimation, such as inference 186.

In some examples, a slope of the non-linear mapping function is based on at least one of a loss function, an input depth of the non-linear mapping function, or a probability distribution of an output depth of the non-linear mapping function. In some examples, the non-linear mapping function is associated with a mean absolute relative error loss function and the slope of the non-linear mapping function at least one of a) increases with the input depth of the non-linear mapping function or b) decreases with a higher probability density of the output depth of the non-linear mapping function.

In some examples, processor(s) 110 may be further configured to control operation of a device (e.g., device 100) based on trained machine learning model 250. In some examples, the device includes a vehicle or a robot. In some examples, as part of controlling operation of the vehicle or the robot, processor(s) 110 may be configured to navigate the vehicle or the robot in environment 195.

In some examples, the system includes cameras 104, cameras 104 including at least three cameras (e.g., a multi-camera set up), the at least three cameras being configured to capture image data 202 and each of the at least three cameras having a different field of view. In some examples, each of cameras 104 has a respective field of view and wherein at least two respective fields of view overlap. In some examples, the one layer is output layer 406 and wherein as part of applying the non-linear mapping function, the one or more processors are configured to apply the non-linear mapping function to the output of machine learning model 250. In some examples, the one layer is a middle layer (e.g., of middle layer(s) 404) and as part of applying the non-linear mapping function, the one or more processors are configured to apply the non-linear mapping function in output layer 406 of machine learning model 250.

In some examples, the plurality of layers includes at least one activation function layer configured to apply an activation function to an output of a respective previous layer. In some examples, the at least one activation function layer includes at least one middle layer (e.g., of middle layers 404) and wherein the activation function of the at least one middle layer comprises at least one of rectified linear unit (ReLU), parametric rectified linear unit (PRELU), or exponential linear unit (ELU). In some examples, wherein the activation function of the at least one middle layer includes PRELU. Iₜ should be noted that activation functions may be stored as model parameters 184.

In some examples, the at least one activation function layer includes output layer 406, and wherein the activation function of output layer 406 includes at least one of rectified linear unit (ReLU), parametric rectified linear unit (PRELU), and exponential linear unit (ELU), Sigmoid, a x Sigmoid, or Softplus. In some examples, the activation function of output layer 406 includes PRELU. In some examples, the output of the one layer does not include disparity data and processor(s) 110 may be configured to train machine learning model 250 without determining disparity data.

In some examples, the non-linear mapping function is a first non-linear mapping function of a plurality of non-linear mapping functions (e.g., non-linear function(s) 190) and wherein the depth data is first depth data. In such examples, processor(s) 110 may be further configured to determine a change in environment 195 and based on the change in environment 195, apply a second non-linear mapping function of the plurality of non-linear mapping functions to the output of the one layer of the plurality of layers to generate second depth data. Processor(s) 110 may be configured to further train the trained machine learning model based on the second depth data. In some examples, as part of applying the second non-linear mapping function of the plurality of non-linear mapping functions to the output of the one layer of the plurality of layers, processor(s) 110 may be configured to stop applying the first non-linear mapping function of the plurality of non-linear mapping functions.

In some examples, processor(s) 110 may execute machine learning model 252 on image data 202, machine learning model 250 including a plurality of layers (e.g., input layer 402, middle layer(s) 404, and output layer 406). Processor(s) 110 may apply a non-linear mapping function (e.g., of non-linear mapping functions 190) to output of one layer of the plurality of layers to predict depth data. In some examples, this machine learning model may be a trained machine learning model. Processor(s) 110 may be further configured to use the depth data in at least one of an advanced driver-assistance system, a robot, an augmented reality device, or a virtual reality device. For example, device 100, which may include an advanced driver-assistance system, a robot, an augmented reality device, or a virtual reality device, may use the depth data in operations performed by device 100, such as navigation.

Examples in the various aspects of this disclosure may be used individually or in any combination.

This disclosure includes the following clauses.

Clause 1. A system comprising: memory configured to store image data captured by a plurality of cameras; and one or more processors communicatively coupled to the memory, the one or more processors being configured to: execute a machine learning model on the image data, the machine learning model comprising a plurality of layers; apply a non-linear mapping function to output of one layer of the plurality of layers to generate depth data; and train the machine learning model based on the depth data to generate a trained machine learning model.

Clause 2. The system of clause 1, wherein a slope of the non-linear mapping function is based on at least one of a loss function, an input depth of the non-linear mapping function, or a probability distribution of an output depth of the non-linear mapping function.

Clause 3. The system of clause 2, wherein the non-linear mapping function is associated with a mean absolute relative error loss function and wherein the slope of the non-linear mapping function at least one of a) increases with the input depth of the non-linear mapping function or b) decreases with a higher probability density of the output depth of the non-linear mapping function.

Clause 4. The system of any of clauses 1-3, wherein the one or more processors are further configured to control operation of a device based on the trained machine learning model.

Clause 5. The system of clause 4, wherein the device comprises a vehicle or a robot and wherein as part of controlling operation of the vehicle or the robot, the one or more processors are configured to navigate the vehicle or the robot in an environment.

Clause 6. The system of any of clauses 1-5, further comprising the plurality of cameras, the plurality of cameras comprising at least three cameras, the at least three cameras being configured to capture the image data and each of the at least three cameras having a different field of view.

Clause 7. The system of any of clauses 1-6, wherein the one layer is an output layer and wherein as part of applying the non-linear mapping function, the one or more processors are configured to apply the non-linear mapping function to the output of the machine learning model.

Clause 8. The system of any of clauses 1-6, wherein the one layer is a middle layer and wherein as part of applying the non-linear mapping function, the one or more processors are configured to apply the non-linear mapping function in an output layer of the machine learning model.

Clause 9. The system of any of clauses 1-8, wherein the plurality of layers comprises at least one activation function layer configured to apply an activation function to an output of a respective previous layer.

Clause 10. The system of clause 9 wherein the at least one activation function layer comprises at least one middle layer, and wherein the activation function of the at least one middle layer comprises at least one of rectified linear unit (ReLU), parametric rectified linear unit (PReLU), or exponential linear unit (ELU).

Clause 11. The system of clause 10, wherein the activation function of the at least one middle layer comprises PRELU.

Clause 12. The system of any of clauses 9-11, wherein the at least one activation function layer comprises an output layer, and wherein the activation function of the output layer comprises at least one of rectified linear unit (ReLU), parametric rectified linear unit (PReLU), and exponential linear unit (ELU), Sigmoid, a x Sigmoid, or Softplus.

Clause 13. The system of clause 12, wherein the activation function of the output layer comprises PRELU.

Clause 14. The system of any of clauses 1-13, wherein the output of the one layer does not include disparity data and wherein to the one or more processors are configured to train the machine learning model without determining the disparity data.

Clause 15. The system of any of clauses 1-14, wherein the non-linear mapping function is a first non-linear mapping function of a plurality of non-linear mapping functions and wherein the depth data is first depth data, and wherein the one or more processors are further configured to: determine a change in an environment; and based on the change in the environment, apply a second non-linear mapping function of the plurality of non-linear mapping functions to the output of the one layer of the plurality of layers to generate second depth data; and further train the trained machine learning model based on the second depth data.

Clause 16. The system of clause 15, wherein as part of applying the second non-linear mapping function of the plurality of non-linear mapping functions to the output of the one layer of the plurality of layers, the one or more processors are configured to stop applying the first non-linear mapping function of the plurality of non-linear mapping functions.

Clause 17. A method comprising: executing a machine learning model on image data captured by a plurality of cameras, the machine learning model comprising a plurality of layers; applying a non-linear mapping function to output of one layer of the plurality of layers to generate depth data; and training the machine learning model based on the depth data to generate a trained machine learning model.

Clause 18. The method of clause 17, wherein a slope of the non-linear mapping function is based on at least one of a loss function, an input depth of the non-linear mapping function, or a probability distribution of an output depth of the non-linear mapping function.

Clause 19. The method of clause 18, wherein the non-linear mapping function is associated with a mean absolute relative error loss function and wherein the slope of the non-linear mapping function at least one of a) increases with the input depth of the non-linear mapping function or b) decreases with a higher probability density of the output depth of the non-linear mapping function.

Clause 20. The method of any of clauses 17-19, further comprising controlling operation of a device based on the trained machine learning model.

Clause 21. The method of clause 20, wherein the device comprises a vehicle or a robot and wherein controlling operation of the vehicle or the robot comprises navigating the vehicle or the robot in an environment.

Clause 22. The method of any of clauses 17-21, wherein the plurality of cameras comprises at least three cameras and wherein each of the at least three cameras having a different field of view.

Clause 23. The method of any of clauses 17-22, wherein the one layer is an output layer and wherein applying the non-linear mapping function comprises applying the non-linear mapping function to the output of the machine learning model.

Clause 24. The method of any of clauses 17-22, wherein the one layer is a middle layer and wherein applying the non-linear mapping function comprises applying the non-linear mapping function in an output layer of the machine learning model.

Clause 25. The method of any of clauses 17-24, wherein the plurality of layers comprises at least one activation function layer configured to apply an activation function to an output of a respective previous layer.

Clause 26. The method of clause 25, wherein the at least one activation function layer comprises at least one middle layer, and wherein the activation function of the at least one middle layer comprises at least one of rectified linear unit (ReLU), parametric rectified linear unit (PReLU), or exponential linear unit (ELU).

Clause 27. The method of clause 26, wherein the activation function of the at least one middle layer comprises PRELU.

Clause 28. The method of any of clauses 25-27, wherein the at least one activation function layer comprises an output layer, and wherein the activation function of the output layer comprises at least one of rectified linear unit (ReLU), parametric rectified linear unit (PReLU), and exponential linear unit (ELU), Sigmoid, a x Sigmoid, or Softplus.

Clause 29. The method of clause 28, wherein the activation function of the output layer comprises PRELU.

Clause 30. The method of any of clauses 17-29, wherein the output of the one layer does not include disparity data and wherein training the machine learning model based on the depth data comprises training the machine learning model without determining the disparity data.

Clause 31. The method of any of clauses 17-30, wherein the non-linear mapping function is a first non-linear mapping function of a plurality of non-linear mapping functions and wherein the depth data is first depth data, and wherein the method further comprises: determining a change in an environment; and based on the change in the environment, applying a second non-linear mapping function of the plurality of non-linear mapping functions to the output of the one layer of the plurality of layers to generate second depth data; and further train the trained machine learning model based on the second depth data.

Clause 32. The method of clause 31, wherein applying the second non-linear mapping function of the plurality of non-linear mapping functions to the output of the one layer of the plurality of layers comprises stopping applying the first non-linear mapping function of the plurality of non-linear mapping functions.

Clause 33. Non-transitory computer-readable storage media comprising instructions, which, when executed, cause one or more processors to: execute a machine learning model on image data captured by a plurality of cameras, the machine learning model comprising a plurality of layers; apply a non-linear mapping function to output of one layer of the plurality of layers to generate depth data; and train the machine learning model based on the depth data to generate a trained machine learning model.

Clause 34. A system comprising: means for executing a machine learning model on image data captured by a plurality of cameras, the machine learning model comprising a plurality of layers; means for applying a non-linear mapping function to output of one layer of the plurality of layers to generate depth data; and means for training the machine learning model based on the depth data to generate a trained machine learning model.

Clause 35. A system comprising: memory configured to store image data captured by a plurality of cameras; and one or more processors communicatively coupled to the memory, the one or more processors being configured to: execute a machine learning model on the image data, the machine learning model comprising a plurality of layers; and apply a non-linear mapping function to output of one layer of the plurality of layers to predict depth data.

Clause 36. The system of clause 35, wherein the one or more processors are further configured to use the depth data in at least one of an advanced driver-assistance system, a robot, an augmented reality device, or a virtual reality device.

Iₜ is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Iₜ should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A system comprising:
memory configured to store image data captured by a plurality of cameras; and
one or more processors communicatively coupled to the memory, the one or more processors being configured to:
execute a machine learning model on the image data, the machine learning model comprising a plurality of layers;
apply a non-linear mapping function to output of one layer of the plurality of layers to generate depth data; and
train the machine learning model based on the depth data to generate a trained machine learning model.

2. The system of claim 1, wherein a slope of the non-linear mapping function is based on at least one of a loss function, an input depth of the non-linear mapping function, or a probability distribution of an output depth of the non-linear mapping function.

3. The system of claim 2, wherein the non-linear mapping function is associated with a mean absolute relative error loss function and wherein the slope of the non-linear mapping function at least one of a) increases with the input depth of the non-linear mapping function or b) decreases with a higher probability density of the output depth of the non-linear mapping function.

4. The system of claim 1, wherein the one or more processors are further configured to control operation of a device based on the trained machine learning model.

5. The system of claim 4, wherein the device comprises a vehicle or a robot and wherein as part of controlling operation of the vehicle or the robot, the one or more processors are configured to navigate the vehicle or the robot in an environment.

6. The system of claim 1, further comprising the plurality of cameras, the plurality of cameras comprising at least three cameras, the at least three cameras being configured to capture the image data and each of the at least three cameras having a different field of view.

7. The system of claim 1, wherein the one layer is an output layer and wherein as part of applying the non-linear mapping function, the one or more processors are configured to apply the non-linear mapping function to the output of the machine learning model.

8. The system of claim 1, wherein the one layer is a middle layer and wherein as part of applying the non-linear mapping function, the one or more processors are configured to apply the non-linear mapping function in an output layer of the machine learning model.

9. The system of claim 1, wherein the plurality of layers comprises at least one activation function layer configured to apply an activation function to an output of a respective previous layer.

10. The system of claim 9, wherein the at least one activation function layer comprises at least one middle layer, and wherein the activation function of the at least one middle layer comprises at least one of rectified linear unit (ReLU), parametric rectified linear unit (PReLU), or exponential linear unit (ELU).

11. The system of claim 10, wherein the activation function of the at least one middle layer comprises PRELU.

12. The system of claim 11, wherein the at least one activation function layer comprises an output layer, and wherein the activation function of the output layer comprises at least one of rectified linear unit (ReLU), parametric rectified linear unit (PReLU), and exponential linear unit (ELU), Sigmoid, a x Sigmoid, or Softplus.

13. The system of claim 12, wherein the activation function of the output layer comprises PRELU.

14. The system of claim 1, wherein the output of the one layer does not include disparity data and wherein to the one or more processors are configured to train the machine learning model without determining the disparity data.

15. The system of claim 1, wherein the non-linear mapping function is a first non-linear mapping function of a plurality of non-linear mapping functions and wherein the depth data is first depth data, and wherein the one or more processors are further configured to:
determine a change in an environment; and
based on the change in the environment, apply a second non-linear mapping function of the plurality of non-linear mapping functions to the output of the one layer of the plurality of layers to generate second depth data; and
further train the trained machine learning model based on the second depth data.

16. The system of claim 15, wherein as part of applying the second non-linear mapping function of the plurality of non-linear mapping functions to the output of the one layer of the plurality of layers, the one or more processors are configured to stop applying the first non-linear mapping function of the plurality of non-linear mapping functions.

17. A method comprising:
executing a machine learning model on image data captured by a plurality of cameras, the machine learning model comprising a plurality of layers;
applying a non-linear mapping function to output of one layer of the plurality of layers to generate depth data; and
training the machine learning model based on the depth data to generate a trained machine learning model.

18. The method of claim 17, wherein a slope of the non-linear mapping function is based on at least one of a loss function, an input depth of the non-linear mapping function, or a probability distribution of an output depth of the non-linear mapping function.

19. The method of claim 18, wherein the non-linear mapping function is associated with a mean absolute relative error loss function and wherein the slope of the non-linear mapping function at least one of a) increases with the input depth of the non-linear mapping function or b) decreases with a higher probability density of the output depth of the non-linear mapping function.

20. The method of claim 17, further comprising controlling operation of a device based on the trained machine learning model.

21. The method of claim 20, wherein the device comprises a vehicle or a robot and wherein controlling operation of the vehicle or the robot comprises navigating the vehicle or the robot in an environment.

22. The method of claim 17, wherein the plurality of cameras comprises at least three cameras and wherein each of the at least three cameras having a different field of view.

23. The method of claim 17, wherein the one layer is an output layer and wherein applying the non-linear mapping function comprises applying the non-linear mapping function to the output of the machine learning model.

24. The method of claim 17, wherein the one layer is a middle layer and wherein applying the non-linear mapping function comprises applying the non-linear mapping function in an output layer of the machine learning model.

25. The method of claim 17, wherein the plurality of layers comprises at least one activation function layer configured to apply an activation function to an output of a respective previous layer.

26. The method of claim 25, wherein the at least one activation function layer comprises at least one middle layer, and wherein the activation function of the at least one middle layer comprises at least one of rectified linear unit (ReLU), parametric rectified linear unit (PRELU), or exponential linear unit (ELU).

27. The method of claim 26, wherein the activation function of the at least one middle layer comprises PRELU.

28. The method of claim 25, wherein the at least one activation function layer comprises an output layer, and wherein the activation function of the output layer comprises at least one of rectified linear unit (ReLU), parametric rectified linear unit (PReLU), and exponential linear unit (ELU), Sigmoid, a x Sigmoid, or Softplus.

29. The method of claim 25, wherein the activation function of the output layer comprises PRELU.

30. The method of claim 17, wherein the output of the one layer does not include disparity data and wherein training the machine learning model based on the depth data comprises training the machine learning model without determining the disparity data.

31. The method of claim 17, wherein the non-linear mapping function is a first non-linear mapping function of a plurality of non-linear mapping functions and wherein the depth data is first depth data, and wherein the method further comprises:
determining a change in an environment; and
based on the change in the environment, applying a second non-linear mapping function of the plurality of non-linear mapping functions to the output of the one layer of the plurality of layers to generate second depth data; and
further train the trained machine learning model based on the second depth data.

32. The method of claim 31, wherein applying the second non-linear mapping function of the plurality of non-linear mapping functions to the output of the one layer of the plurality of layers comprises stopping applying the first non-linear mapping function of the plurality of non-linear mapping functions.

33. A system comprising:
means for executing a machine learning model on image data captured by a plurality of cameras, the machine learning model comprising a plurality of layers;
means for applying a non-linear mapping function to output of one layer of the plurality of layers to generate depth data; and
means for training the machine learning model based on the depth data to generate a trained machine learning model.

34. A system comprising:
memory configured to store image data captured by a plurality of cameras; and
one or more processors communicatively coupled to the memory, the one or more processors being configured to:
execute a machine learning model on the image data, the machine learning model comprising a plurality of layers; and
apply a non-linear mapping function to output of one layer of the plurality of layers to predict depth data.

35. The system of claim 34, wherein the one or more processors are further configured to use the depth data in at least one of an advanced driver-assistance system, a robot, an augmented reality device, or a virtual reality device.
